(19) United States
(12) Patent Application Publication
(10) Pub. No.: US 2013/0125448 A1
(43) Pub. Date: May 23, 2013

(54) Automatic setting fishhook

(71) Applicant: Gary M. Young, Spotsylvania, VA (US)

(72) Inventor: Gary M. Young, Spotsylvania, VA (US)

(21) Appl. No.: 13/373,623

(22) Filed: Nov. 23, 2011

(51) Int. Cl. A01K 83/00

(52) U.S. Cl. 43/34

(57) ABSTRACT

A self-setting hook is disclosed that is easily made from one-piece of wire. The hook wire is bent to form a throat, and then coiled into a spring like section in the shank portion of the hook. At least one coil protrudes beyond of the other coils, forming a loop that engages a catch at the proximal end of the wire. The wire is bent to form both an eye and an arm with a catch at the proximal end. The catch engages the loop, and energy is released that is stored in the coil, setting the hook upon slight disturbance to the hook.

### CROSS REFERENCE TO RELATED APPLICATIONS

None

### STATEMENT REGARDING FEDERALLY SPONSORED RESEARCH OR DEVELOPMENT

Not applicable.

### THE NAMES OF PARTIES TO A JOINT RESEARCH AGREEMENT

None

### INCORPORATION-BY REFERENCE OF MATERIAL SUBMITTED ON A COMPACT DISK

None

### BACKGROUND OF THE INVENTION

This invention relates to fishhooks and more specifically to a fishhook that is augmented to automatically set the hook, without a response from the fisherman.

The prior art is replete with fishhooks and fishhook setters. In general, a fish contacts the hook and a compressed spring often on a hair trigger is released to set the hook in the fish's mouth. These fishhooks are unnecessarily complex and sensitive in a cocked condition and frequently are unsuccessful in hooking the fish. The sudden release also often results in a missed opportunity if the fish releases the trigger by gentle nudging before it attempts to swallow the baited hook or if the sudden release rips through the fish.

In applicant's own prior invention, the subject of U.S. Pat. No. 4,854,070 the hook is mounted in such a way that the hook will set itself in the fish's mouth upon the slightest nibble from a fish. In addition, the fishhook of applicant's prior invention was constructed to keep the hook from becoming snagged in vegetation in the water.

It is important to continuously monitor the fishing line while fishing. When a fish bites the bait, the angler must be prepared to set the hook. In general, if the fish swallows the bait, this is not a problem since the angler will feel a tug on the line and knows that the hook is set. Problems arise, however, since the angler may not feel a tug from the fish on the line. This can happen if the line is tangled at the end of the fishing pole or if the angler has stepped away from his rod. This may happen in surf fishing where a rod is inserted in a rod holster, for instance. If the line is tangled at the tip of the fishing rod, a slight tug will not be transmitted to the angler, and he will not know to set the hook. In addition, a fish often may lightly bite the bait but not actually have enough of the bait in his mouth to be captured if the hook were to be set by the angler. The fish may be merely mouthing the bait and move away from the bait when the angler attempts to set the hook.

Another problem encountered during fishing is the fact that the hook will often snag upon vegetation. When this happens, the hook is sometimes lost because it cannot be unhooked from the vegetation.

In the past, the prior art has attempted to create a hook that is weed-proof by putting various members in front of the hook's barb in order to prevent the barb from snagging in the vegetation. This has been done in a variety of ways. However, the prior art does not show a fishing hook that is constructed so as to set itself in the fish's mouth upon the slightest touch from a fish.

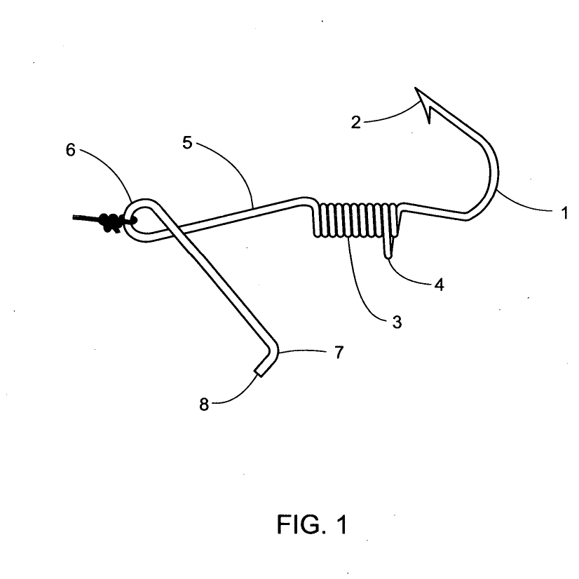

Applicant's prior hook assembly comprises a barbed hook member that is connected to a coil spring member. The hook and spring combination have an eyelet member formed at one end, and the fishing line is attached to the eyelet. The portion of the hook from the eyelet extending axially to the point where the barb hook begins to bend laterally is known as the shank. The shank includes the eyelet and the spring. A hook latch member is formed perpendicularly from the hook shank and extends away from the shank in the opposite direction that said hook extends. The portion of the latch removed from the shank portion is turned slightly upwardly. The latch member has a slightly upturned hooked end. A one-piece retainer bar has an eyelet that is attached to the eyelet and a latch eyelet that will hook on the latch member. The connection between the latch member and the latch eyelet is such that the hook must be bent in the direction that the latch member extends in order for the retainer bar to be of sufficient length that the eyelet can hook on the latch member. When the hook is bent back into this position, there is a stress in the coil spring that causes a force to bias the hook member counterclockwise as seen in FIG. 1 of the patent.

The fish hook subject to applicant's prior patent, U.S. Pat. No. 7,353,633 suffered the serious drawback that the hook was overly complicated, since it comprised several parts. The industry standard, and the type of hook that fishermen expect, is a one-piece, wire fishhook. Hooks made from a single piece of wire are also more economical to produce, with commensurate profit increases for the manufacturer.

### DESCRIPTION OF RELATED ART INCLUDING INFORMATION DISCLOSED UNDER 37 C.F.R. §§1.97, 1.198

U.S. Pat. No. 7,353,633 to Lane discloses a spring augmented fishhook comprising a hook member with an eye on a first end of an elongate leg portion and a hook on a second end of the leg portion. A coil spring is included that has a diameter smaller than the eye and forms a spring channel longitudinal through its center through which the elongate leg portion passes. A clip resiliently bends at a point of flexure into elongate first and second clip members. The first clip member passes downward through the eye and then through the channel and extending beyond spring upper and lower ends with a first latch member on its ends The second clip member extends generally downward with a second latch member on its end matching the first latch member such that the first and second latch members latch together as the first and second clip members are urged together under flexures. The spring held on the hook member leg portion between the eye and the latched first and second clip members as spring stops such that when the hook is pulled downward such as by a fish with the clip stationary relative to the hook member, the spring compresses between the eye and the latched clip members allowing limited movement of the hook against spring bias when initially pulled.

### BRIEF SUMMARY OF THE INVENTION

In the instant invention, the retainer bar and spring member have been united into a one-piece construction. This is not only simpler and cheaper to manufacture, but it is also more accepted by fishermen. Additionally, the one-piece design complies with regulations for fishing tournaments, which prohibited applicant's patented fishhook, where the retainer bar and spring were separate components. Also, the fishhook is manufactured from a one-piece of wire, decreasing manufacturing costs.

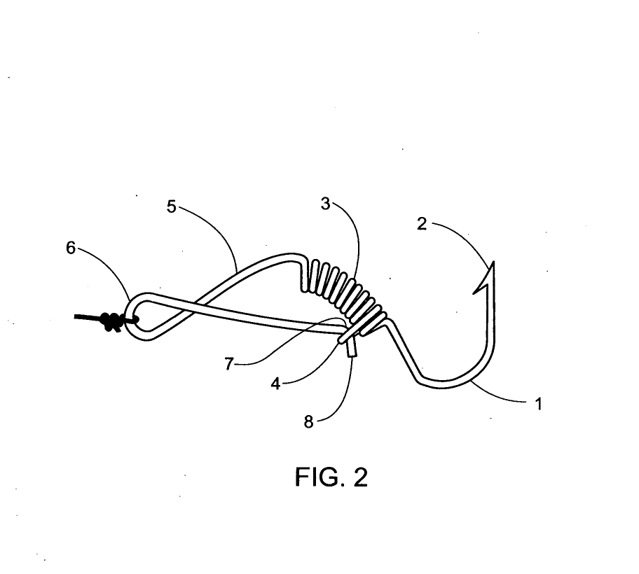

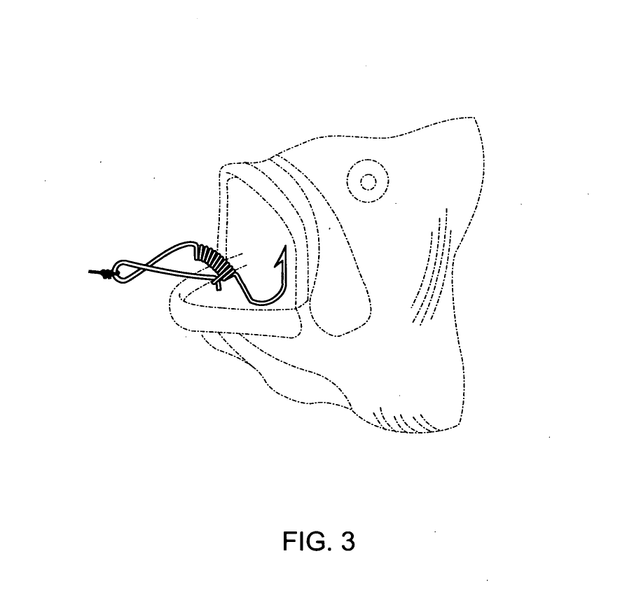

In the present invention, hook includes a normal single hook and barb (2). It is understood that the subject fishhook could be a double or even a treble hook, so long as the hook may be adequately bent to store sufficient mechanical energy to penetrate the fish and therefore hook the fish, and the force of the hook is directed through the point of the hook. After the throat (1) of the hook, the hook wire is convoluted into a coil spring (3) forming a coiled shank portion of the hook. The wire again becomes straight wire (5), with no coil, at the top portion of the shank. At the terminal end of the shank, the wire is bent sufficiently to form an eye (6) to attach fishing line. At the eye in the fishhook, the wire is bent about 270 degrees from the hook shank. It is to be understood that the exact angle is a function of the wire gauge, and tensile properties of the wire. The wire in this section must be sufficiently rigid to enable coil (3) to be bent towards bend (7) when the hook is engaged and in the self-hooking configuration, as seen in FIGS. 2 and 3. A final bend (7) in the hook wire forms a catch (8) that is intended to engage loop (4) formed in coil (3) that protrudes outwardly from coil (3). When a fish tugs at the hook, the catch (8) in the hook is released from the loop (4), thrusting point 2 into the fish.

### BRIEF DESCRIPTION OF THE SEVERAL FIGURES OF THE DRAWINGS

FIG. (1) shows the fishhook of the present invention in a condition where the self-hooking mechanism is unengaged.

FIG. (2) shows the fishhook of the present invention when the self-hooking mechanism is engaged and the fishhook is ready to self-hook a fish.

FIG. (3) shows the fishhook of the present invention in an engaged condition in the mouth of a fish.

### DETAILED DESCRIPTION OF THE INVENTION

The present invention comprises a one-piece hook constructed from a metallic wire that has sufficient spring-like mechanical properties to store mechanical energy adequate to hook a fish. Stainless steel wire is the preferred material, because it demonstrates both the necessary mechanical spring properties and because it is corrosion resistant, particularly in a salt-water environment. Any wire that has the proper mechanical properties may be used, however.

One-piece of wire is bent to form a throat, terminating at a distal portion, the distal portion including a sharp point. The wire extends from the throat into a shank portion, wherein the shank portion is wrapped in a plurality of loops forming a coiled portion extending circumferentially around the centerline of the shank portion of the hook. The coiled portion further includes a loop that protrudes beyond the coiled portion, thereby forming a loop that is intended to engage a catch portion at the proximal end of the wire. The wire further extends beyond the circumferential portion that is looped, in an axial direction, forming a top section of the fishhook shank, terminating at the eye of the fishhook. At the eye of the hook, wire is wrapped to form the eye of the fishhook at the terminal portion of the top section of the shank, and wherein the wire further extends in a second section beyond the eye of the fishhook. A final bend is made at the proximal end of the wire, forming a catch intended to engage the loop formed on the coiled section. The bend forming the eye of the hook is made at an angle sufficient such that when the catch at the proximal end of the second section of the wire that extends beyond the eye of the fishhook is engaged in the loop that protrudes beyond the plurality of coils, the coiled portion of the fishhook shank stores energy sufficient for the point of the hook to penetrate a fish.

The fishhook has the normal point and barb (2). It is understood that the hook may be made barbless as is conventional when fish are to be safely released back into the water after capture. The metallic wire curves to form a normal fishhook throat (1), of any conventional shape. Adjacent to the throat (1) of the fishhook, at the lower portion of shank of the fishhook, the wire is convoluted, along the centerline of the fishhook shank portion, forming coils (3) in a spring-like configuration, with reference to FIG. 1. One of the coils, preferably adjacent the shank at the throat end, protrudes outwardly from the other coils, forming a loop (4) that extends outward from the other coils (3). The purpose of this extended loop (4) is to engage catch (8), located at the proximal portion of the fishhook, where point (2) defines distal. When catch (8) is engaged in loop (4), the hook bends backwards, as seen in FIG. 2. In this way, when the catch (8) is released from the loop (4), the point (2) is thrust into the fish. Only a slight disturbance to the bait causes the shank to bend in the coil section (3), releasing catch (8) from loop (4). When the catch is released, the mechanical energy stored in the coil spring is directed in the vector that has its direction in the line of the hook point and barb.

After the final coil in section (3) of the fishhook shank, the hook is again of a single, straight wire construction (5). At the conventional position along the shank of the hook, at the terminal end of the fishhook shank opposite the throat of the fishhook, the wire is bent in the plane of the fishhook throat, as seen in FIG. 1, forming eye (6). The exact angle that the wire is bent depends on the mechanical properties of the wire. Normally, the wire forms a bend of about 270 degrees, as seen in FIG. 1. The angle must be such that when the catch (8) is engaged into the loop (4), sufficient mechanical energy is stored in the fishhook to penetrate the fish if the fishhook is triggered by a fish. As seen in FIG. 1, the bend at the top of the shank of the fishhook also forms the eye (6) of the fishhook, where the fishing line is attached. After forming eye (6), the wire extends in a straight section. Finally, there is another bend (7), as seen in FIG. 1. The proximal end of the wire forms catch (8) which is intended to engage the loop (4) when the hook is sprung and ready to self-hook a fish.

The one-piece hook as seen in FIG. 1 is the preferred embodiment.

To make the hook, a single piece of wire of is bent to form a throat, the distal portion including a sharp point (2). The sharp point is barbed in any conventional manner. The wire extends from the throat (1) into a shank portion, wherein the shank portion is wrapped in a plurality of coils (3) extending circumferentially around the centerline of the shank portion of the hook. When the coils are wrapped, one or more of the coils are bent such that they protrude outwardly beyond the coil (3), thereby forming a loop (4) that is intended to engage a catch portion (8) of the one-piece wire. The catch portion (8) is formed by bending the proximal end of the wire at (7). The exact order that the various bends are performed is unimportant and largely dependent of manufacturing economic conditions.

1. A fishhook that is self-setting, comprising:
one-piece of wire that is bent to form a throat, terminating at a distal portion, the distal portion including a sharp point, where the wire extends from the throat into a shank portion, wherein the shank portion is wrapped in a plurality of loops forming a coiled portion extending circumferentially around the centerline of the shank portion of the hook, further including a loop that protrudes beyond the coiled portion, thereby forming a loop that is intended to engage a catch portion at the proximal end of the wire, the wire further extending beyond the circumferential portion that is looped, in an axial direction, forming a top section of the fishhook shank, terminating at the eye of the fishhook, wherein the wire is wrapped to form the eye of the fishhook at the terminal portion of the top section of the shank, and wherein the wire further extends in a second section beyond the eye of the fishhook, and further includes a final bend at the proximal end of the wire, forming a catch intended to engage the loop formed on the coiled section, wherein the bend forming the eye of the hook is made at an angle sufficient such that when the catch at the proximal end of the second section of the wire that extends beyond the eye of the fishhook is engaged in the loop that protrudes beyond the plurality of coils, the coiled portion of the fishhook shank stores energy sufficient for the point of the hook to penetrate a fish.

2. The fishhook of claim 1 wherein two or more loops protrude beyond the coiled section of the shank.

3. The fishhook of claim 1, wherein the hook includes a barbed portion.

4. The fishhook of claim 1, wherein the wire is stainless steel.

5. The fishhook of claim 1, wherein the wire is round.

6. The fishhook of claim 1 wherein the top section of the shank is wrapped to about 270 degrees from the shank, forming both the eye of the hook and the second section.
